(19) United States
(12) Patent Application Publication
(10) Pub. No.: US 2011/0298770 A1
(43) Pub. Date: Dec. 8, 2011

(54) ACTIVE MATRIX DISPLAY DEVICE

(75) Inventors: Pei-Yi CHEN, Hsin-Chu (TW); Chun-Wei HUANG, Hsin-Chu (TW)

(73) Assignee: AU Optronics Corp.

(21) Appl. No.: 12/792,828

(22) Filed: Jun. 3, 2010

(51) Int. Cl. G06F 3/038; G09G 3/20

(52) U.S. Cl. 345/211; 345/55

(57) ABSTRACT

An exemplary active matrix display device includes a plurality of gate signal lines, a plurality of data signal lines and a plurality of pixel rows. The gate signal lines are independently driven from one another. Each of the pixel rows is electrically coupled to one of the gate signal lines and a part of the data signals lines. The pixel rows include a first pixel row and a second pixel row. The first pixel row and the second pixel row are not neighboring with each other. The gate signal line electrically coupled with the first pixel row and the gate signal line electrically coupled with the second pixel row are synchronously enabled.

### CROSS-REFERENCE TO RELATED APPLICATIONS

This application is based upon and claims the benefit of priority from the prior Taiwan Patent Application No. 098143399, filed Dec. 17, 2009, the entire contents of which are incorporated herein by reference.

### BACKGROUND

1. Technical Field

The present invention generally relates to display technology fields and, particularly to an active matrix display device.

2. Description of the Related Art

In the market of display device, a driving frame frequency of most of liquid crystal display (LCD) panels is 60 Hz or 120 Hz. When playing dynamic image frames, an image ghost may appear due to the driving frame rate is not high enough. To solve this problem, a single action can be divided into many frames to be continuously played. Thus, the driving frame rate of the display panel must be much faster.

Usually, a driving time period of a frame is 1/f (where f is the driving frame frequency of the display panel). For a current standard of full high definition (FHD) that is 1920*1080 pixels, a charging time of a single frame driven at 60 Hz is about 16 milliseconds (ms), and a charging time of a single frame driven at 120 Hz is about 8 ms. If a driving frame frequency of 240 Hz is employed, the charging time of a single frame will be shortened to be 4 ms, and correspondingly a charging time of a single pixel in such frame is about only 3.5 microseconds (νs).

To solve the problem of the charging time of pixel is excessively short, a proposed solution in the prior art is that each two neighboring/adjacent gate signal lines are electrically connected to each other, so that two pixel rows can be charged at the same time. Herein, due to two pixel rows are written with display data signals at the same time, the charging time of pixel in a single pixel row is doubled.

However, the prior art would have following disadvantages: due to each two neighboring gate signal lines are electrically connected to each other, in one aspect, during a circuit layout design, other circuit(s) must be avoided be arranged between the two neighboring gate signal lines, which results in the layout design becomes too complex, in another aspect, signals provided to each two neighboring gate signal lines electrically connected to each other may mutually influence and interfere with each other.

### BRIEF SUMMARY

Accordingly, the present invention is directed to an active matrix display device, so as to address the above-mentioned issues associated with the prior art.

More specifically, in a first aspect of an embodiment of the present invention, an active matrix display device includes a plurality of gate signal lines, a plurality of data signal lines and a plurality of pixel rows. The gate signal lines are independently driven from one another. Each of the pixel rows is electrically coupled to one of the gate signal lines and a part of the data signals lines. The pixel rows include a first pixel row and a second pixel row. The first pixel row and the second pixel row are not neighboring/adjacent with each other. The gate signal line electrically coupled with the first pixel row and the gate signal line electrically coupled with the second pixel row are synchronously enabled.

In an embodiment of the present invention, the gate signal line electrically coupled with the first pixel row and the gate signal line electrically coupled with the second pixel row have at least one of the other/rest gate signal line(s) arranged between.

In an embodiment of the present invention, a total length of charging time for the first pixel row and the second pixel row synchronously receiving display data signals from the data signal lines is substantially equal to a length of charging time for any one of the first pixel row and the second pixel row.

In an embodiment of the present invention, the active matrix display device includes a color filter substrate, a thin film transistor (TFT) array substrate and a display layer arranged/interposed between the thin film transistor array substrate and the color filter substrate. The gate signal lines, the data signal lines and the pixel rows all are arranged on the thin film transistor array substrate.

In a second aspect of an embodiment of the present invention, an active matrix display device includes a first gate signal line, a second gate signal line, a plurality of data signal lines, a first pixel row and a second pixel row. The first gate signal line and the second gate signal line are independently driven from each other. The first pixel row and the second pixel row are respectively electrically coupled to the first gate signal line and the second gate signal line. The first pixel row is electrically coupled to a part of the data signal lines. The second pixel row is electrically coupled to another part of the data signal lines. Moreover, the first gate signal line and the second gate signal line are enabled in order (i.e., generally sequentially enabled), and an enabled time period of the first gate signal line and another enabled time period of the second gate signal line are partially overlapped with each other.

In an embodiment of the present invention, the first pixel row and the second pixel row are neighboring with each other.

In an embodiment of the present invention, a total length of charging time for the first pixel row and the second pixel row orderly/sequentially receiving display data signals from the data signal lines is substantially shorter than the sum of lengths of charging time for the first pixel row and the second pixel row.

In an embodiment of the present invention, the active matrix display device includes a color filter substrate, a thin film transistor array substrate and a display layer arranged between the thin film transistor array substrate and the color filter substrate. The first and second gate signal lines, the data signal lines, and the first and second pixel rows all are arranged on the thin film transistor array substrate.

In the above-mentioned embodiments of the present invention, the charging time of pixel at a given display panel driving frame frequency is lengthened by employing the solution of that the gate signal lines are independently driven from one another. Compared with the prior art, it is unnecessary to take in consideration that how to avoid arranging other circuit(s) between the connected gate signal lines associated with the prior art during the circuit layout design, and gate driving signals on the gate signal lines may not mutually influence and interfere with each other.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic exploded perspective view of an active matrix display device according to an embodiment of the present invention;

FIG. 2 is a schematic partial circuit diagram of a TFT array substrate of the active matrix display device as shown in FIG. 1;

FIG. 3 is a timing diagram of gate driving signals of the gate signal lines on the TFT array substrate as shown in FIG. 2;

FIG. 4 is a schematic partial circuit diagram of a TFT array substrate according to another embodiment of the present invention;

FIG. 5 is a timing diagram of gate driving signals of the gate signal lines on the TFT array substrate as shown in FIG. 4;

FIG. 6 is a schematic partial circuit diagram of a TFT array substrate according to still another embodiment of the present invention; and

FIG. 7 is a timing diagram of gate driving signals of the gate signal lines on the TFT array substrate as shown in FIG. 6.

### DETAILED DESCRIPTION

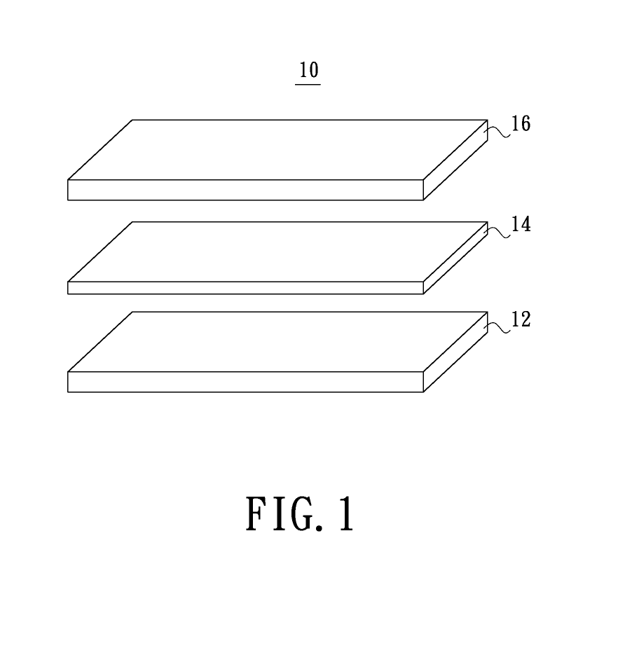

Referring to FIG. 1, showing a schematic exploded perspective view of an active matrix display device according to an embodiment of the present invention. As shown in FIG. 1, the active matrix display device such as an active matrix LCD display device 10 includes a thin film transistor (TFT) array substrate 12, a color filter substrate 16 and a liquid crystal layer (i.e., a type of display layer) 14 between the TFT array substrate 12 and the color filter substrate 16. In the illustrated embodiment, the active matrix LCD display device 10 is taken for explanation but not to limit the present invention. The present invention also can be adapted for the other types of display devices such as a plasma display device, an organic electroluminescence display device, and so on.

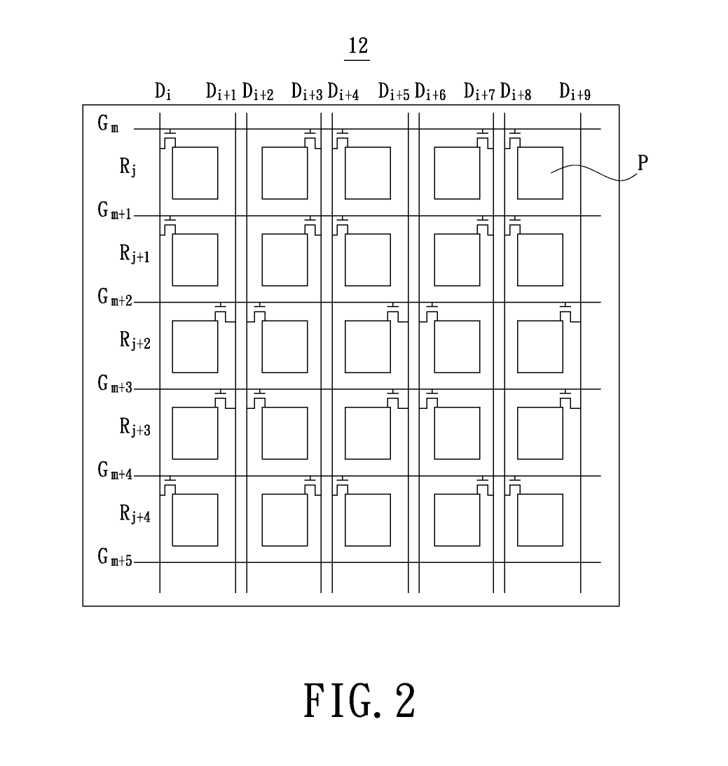

Referring to FIG. 2, showing a schematic partial circuit diagram of the TFT array substrate 12 in FIG. 1. As shown in FIG. 2, the TFT array substrate 12 has gate signal lines Gₘ˜Gₘ₊₅, date signal lines Dᵢ˜Dᵢ₊₉ and pixel rows Rⱼ˜Rⱼ₊₄ configured/disposed thereon. The gate signal lines Gₘ˜Gₘ₊₅ are independently driven from one another. That is, the gate signal lines Gₘ˜Gₘ₊₅ are configured without electrical connection among therewith, and the heads and tails thereof are disconnected from one another. The data signal lines Dᵢ˜Dᵢ₊₉ are arranged crossing/intersecting with the gate signal lines Gₘ˜Gₘ₊₅. The pixel rows Rⱼ˜Rⱼ₊₄ are respectively electrically connected to the gate signal lines Gₘ˜Gₘ₊₄. Each of the pixel rows Rⱼ˜Rⱼ₊₄ includes a plurality of pixels P, for example, a red (R) pixel, a green (G) pixel, and a blue (B) pixel arranged in a certain regulation (arranged in a strip or delta manner). The pixels P of each of the pixel rows Rⱼ˜Rⱼ₊₄ are electrically coupled to a part of the data signals lines Dᵢ˜Dᵢ₊₉. For example, the pixels P in the pixel row Rⱼ are respectively electrically coupled to Dᵢ, Dᵢ₊₃, Dᵢ₊₄, Dᵢ₊₇ and Dᵢ₊₈ of the data signal lines Dᵢ˜Dᵢ₊₉. The pixel row Rⱼ₊₂ is disposed spaced from the pixel row Rⱼ by the pixel row Rⱼ₊₁ and the pixels P in the pixel row Rⱼ₊₂ are respectively electrically coupled to Dᵢ₊₁, Dᵢ₊₂, Dᵢ₊₅, Dᵢ₊₆ and Dᵢ₊₉ of the data signal lines Dᵢ˜Dᵢ₊₉. In addition, the gate signal lines Gₘ˜Gₘ₊₅ can be electrically coupled to a gate driving circuit (not shown) formed on the TFT array substrate 12 and for receiving gate driving signals. The data signal lines Dᵢ, Dᵢ₊₃, Dᵢ₊₄, Dᵢ₊₇ and Dᵢ₊₈ and the data signal lines Dᵢ₊₁, Dᵢ₊₂, Dᵢ₊₅, Dᵢ₊₆ and Dᵢ₊₉ can be respectively electrically coupled to two data driving circuits (not shown) arranged on the TFT array substrate 12 and for receiving display data signals.

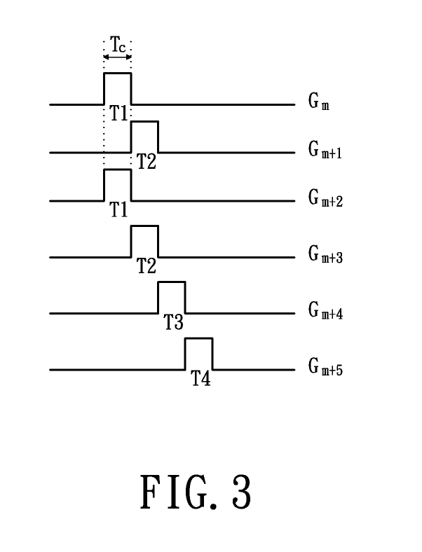

Referring to FIG. 3, showing a timing diagram of the gate driving signals of the gate signal lines Gₘ˜Gₘ₊₅ in FIG. 2. Referring to FIGS. 2 and 3 together, the gate signal lines Gₘ and Gₘ₊₂ are synchronously enabled during a time period T1. Correspondingly, the pixel rows Rⱼ and Rⱼ₊₂ being not neighboring with each other and respectively electrically coupled to the gate signal lines Gₘ and Gₘ₊₂ synchronously receive display data from the data signal lines D₁˜Dᵢ₊₉, a total length of charging time for the pixel rows Rⱼ and Rⱼ₊₂ synchronously receiving the display data from the data signal lines Dᵢ˜Dᵢ₊₉ is Tc. Herein, a length of charging time for the pixel rows Rⱼ receiving the display data from the data signal lines Dᵢ, Dᵢ₊₃, Dᵢ₊₄, Dᵢ₊₇, Dᵢ₊₈ and another length of charging time for the pixel rows Rⱼ₊₂ receiving the display data from the data signal lines Dᵢ₊₁, Dᵢ₊₂, Dᵢ₊₅, Dᵢ₊₆, Dᵢ₊₉ both are equal to the time period T1, and in this situation, Tc is substantially equal to T1. Similarly, the gate signal lines Gₘ₊₁ and Gₘ₊₃ are synchronously enabled during a time period T2. Correspondingly, the pixel rows Rⱼ₊₁ and Rⱼ₊₃ being not neighboring with each other and respectively electrically coupled to the gate signal lines Gₘ₊₁ and Gₘ₊₃ synchronously receive display data from the data signal lines D₁˜Dᵢ₊₉, a total length of charging time for the pixel rows Rⱼ₊₁ and Rⱼ₊₃ synchronously receiving the display data from the data signal lines Dᵢ˜Dᵢ₊₉ is equal to the time period T2. Thus, compared with a situation that only a single pixel row is charged during a time period, since the two pixel rows are synchronously charged at the same time, at the prerequisite of a given display panel driving frame frequency, the length of charging time of each pixel is doubled. In addition, due to the gate signal lines Gₘ˜Gₘ₊₅ are independently driven from one another, during the circuit layout design, it is unnecessary to take in consideration that how to avoid arranging other circuit(s) between the connected gate signal lines associated with the prior art and the gate driving signals of gate signal lines Gₘ˜Gₘ₊₅ may not mutually influence and interfere with each other. Furthermore, as seen from FIG. 3, the gate signal lines Gₘ₊₄ and Gₘ₊₅ are respectively enabled during time periods T3 and T4.

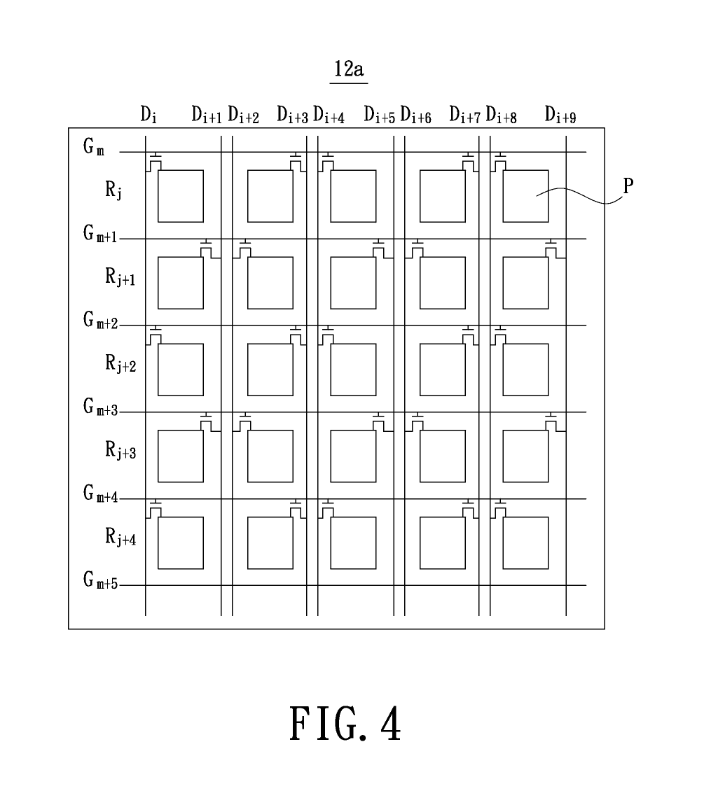

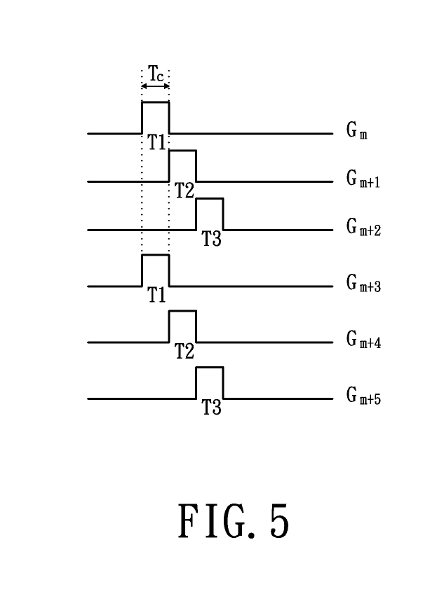

The above-mentioned embodiment of the present invention is not limited to charge the two pixel rows spaced from each other by another rest pixel row at the same time. Two pixel rows spaced from each other by a plurality of other pixel rows also can be charged at the same time, for example, FIGS. 4 and 5 showing an embodiment of two pixel rows spaced from each other by two other pixel rows are charged at the same time.

More specifically, as shown in FIG. 4, gate signal lines Gₘ˜Gₘ₊₅, date signal lines Dᵢ˜Dᵢ₊₉ and pixel rows Rⱼ˜Rⱼ₊₄ are configured on the TFT array substrate 12a. The gate signal lines Gₘ˜Gₘ₊₅ are independently driven from one another. That is, the gate signal lines Gₘ˜Gₘ₊₅ are configured without electrical connection among therewith, and heads and tails thereof are disconnected from one another. The data signal lines Dᵢ˜Dᵢ₊₉ are arranged crossing with the gate signal lines Gₘ˜Gₘ₊₅. The pixels Rⱼ˜Rⱼ₊₄ are respectively electrically connected to the gate signal lines Gₘ˜Gₘ₊₄. Each of the pixel rows Rⱼ˜Rⱼ₊₄ includes a plurality of pixels P, for example, a red (R) pixel, a green (G) pixel, and a blue (B) pixel arranged in a certain regulation (e.g., arranged in a strip or delta manner). The pixels P of each of the pixel rows Rⱼ˜Rⱼ₊₄ are electrically coupled to a part of the data signals lines Dᵢ˜Dᵢ₊₉. For example, the pixels P in the pixel row Rⱼ are respectively electrically coupled to Dᵢ, Dᵢ₊₃, Dᵢ₊₄, Dᵢ₊₇ and Dᵢ₊₈ of the data signal lines Dᵢ˜Dᵢ₊₉. The pixel row Rⱼ₊₃ is disposed spaced from the pixel row Rⱼ by the pixel rows Rⱼ₊₁ and Rⱼ+₂, and the pixels P in the pixel row Rⱼ₊₃ are respectively electrically coupled to Dᵢ₊₁, Dᵢ₊₂, Dᵢ₊₅, Dᵢ₊₆ and Dᵢ₊₉ of the data signal lines Dᵢ˜Dᵢ₊₉. Herein, the pixels P in the pixel row Rⱼ₊₁ neighboring with the pixel row Rⱼ are also respectively electrically coupled to Dᵢ₊₁, Dᵢ₊₂, Dᵢ₊₅, Dᵢ₊₆ and Dᵢ₊₉ of the data signal lines Dᵢ˜Dᵢ₊₉.

Referring to FIGS. 4 and 5 together, the gate signal lines Gₘ and Gₘ₊₃ are synchronously enabled during a time period T1. Correspondingly, the pixel rows Rⱼ and Rⱼ₊₃ being not neighboring with each other and respectively electrically coupled to the gate signal lines Gₘ and Gₘ₊₃ synchronously receive display data from the data signal lines Dᵢ˜Dᵢ₊₉, a total length of charging time for the pixel rows Rⱼ and Rⱼ₊₃ receiving the display data from the data signal lines Dᵢ˜Dᵢ₊₉ is Tc. Herein, a length of charging time for the pixel rows Rⱼ receiving the display data from the data signal lines Dᵢ, Dᵢ₊₃, Dᵢ₊₄, Dᵢ₊₇, Dᵢ₊₈ and another length of charging time for the pixel rows Rⱼ₊₃ receiving the display data from the data signal lines Dᵢ₊₁, Dᵢ₊₂, Dᵢ₊₅, Dᵢ₊₆, Dᵢ₊₉ both are equal to the time period T1, and in this situation, Tc is substantially equal to T1. Similarly, the gate signal lines Gₘ₊₁ and Gₘ₊₄ are synchronously enabled during a time period T2. Correspondingly, the pixel rows Rⱼ₊₁ and Rⱼ₊₄ are being not neighboring with each other and respectively electrically coupled to the gate signal lines Gₘ₊₁ and Gₘ₊₄ synchronously receive display data from the data signal lines Dᵢ˜Dᵢ₊₉, a total length of charging time for the pixel rows Rⱼ₊₁ and Rⱼ₊₄ receiving the display data from the data signal lines Dᵢ˜Dᵢ₊₉ is equal to the time period T2. Furthermore, the gate signal lines Gₘ₊₂ and Gₘ₊₅ are synchronously enabled during a time period T3.

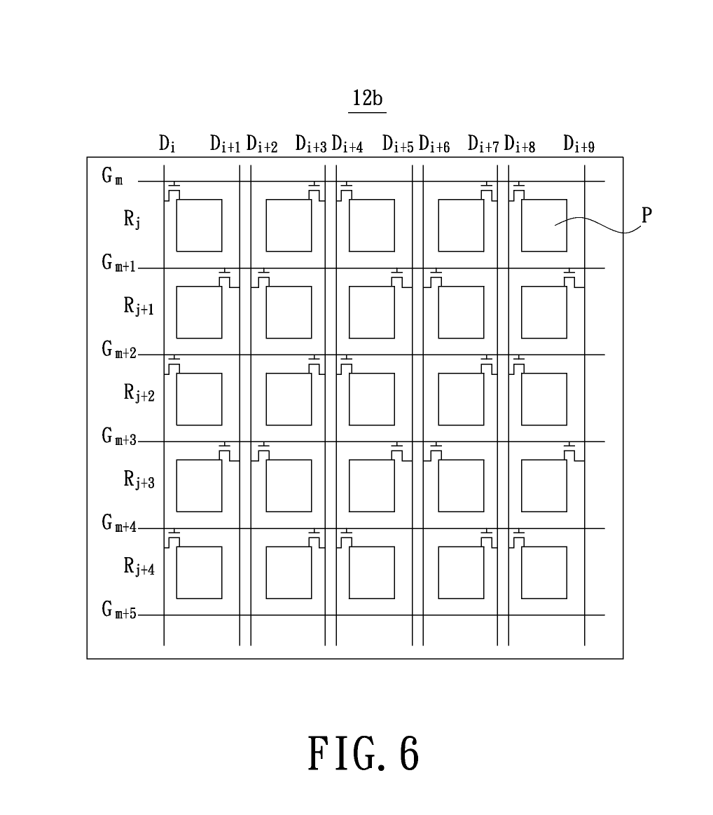

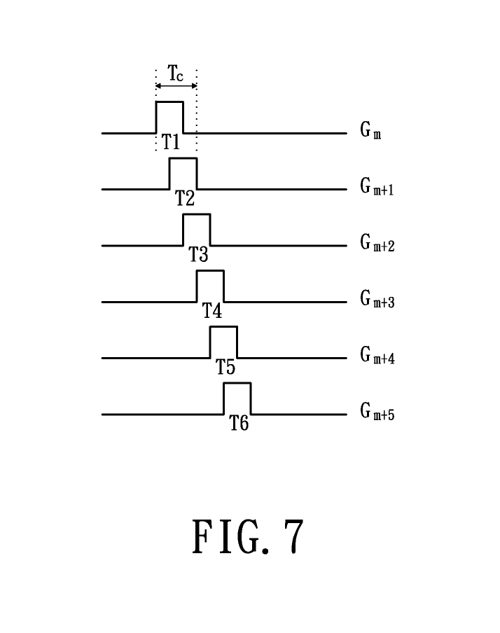

The present invention is not limited to the above-mentioned embodiments of charging two pixel rows at the same time to achieve the purpose of lengthening the charging time of pixel at a given driving frame frequency, another way/solution also can be adopted. For example, as shown in FIGS. 6 and 7, with a given display panel driving frame frequency, the length of charging time of pixel is lengthened by using the approach of sequentially/orderly enabling a plurality of gate signal lines and the enabled time periods of the gate signal lines being partially overlapped with one another.

In particular, a TFT array substrate 12b shown in FIG. 6 is the same as the TFT array substrate 12a shown in FIG. 4, and thus will not be repeated herein.

Referring to FIGS. 6 and 7 together, the gate signal lines Gₘ and Gₘ₊₁ are enabled in order (i.e., generally sequentially enabled) in respective time periods T1 and T2. The enabled time periods T1 and T2 are partially overlapped with each other. Correspondingly, the pixel rows Rⱼ and Rⱼ₊₁ being neighboring with each other and respectively electrically coupled to the gate signal lines Gₘ and Gₘ₊₁ sequentially/orderly receive display data from the data signal lines Dᵢ˜Dᵢ₊₉, a total length of charging time for the pixel rows Rj and Rⱼ₊₃ orderly receiving the display data from the data signal lines Dᵢ˜Dᵢ₊₉ is Tc. Herein, the length of charging time for the pixel rows Rⱼ receiving the display data from the data signal lines Dᵢ, Dᵢ₊₃, Dᵢ₊₄, Dᵢ₊₇, Dᵢ₊₈ is equal to the enabled time period T1, and the length of charging time for the pixel rows Rⱼ₊₁ receiving the display data from the data signal lines Dᵢ₊₁, Dᵢ₊₂, Dᵢ₊₅, Dᵢ₊₆, Dᵢ₊₉ is equal to the enabled time period T2. Tc is less than the sum of the lengths of charging time T1 and T2. Similarly, the gate signal lines Gₘ₊₁ and Gₘ₊₂ are enabled in order in respective time periods T2 and T3, and the enabled time periods T2 and T3 are partially overlapped with each other. The gate signal lines Gₘ₊₂ and Gₘ₊₃ are enabled in order in respective time periods T3 and T4, and the enabled time periods T3 and T4 are partially overlapped with each other. The gate signal lines Gₘ₊₃ and Gₘ₊₄ are enabled in order in respective time periods T4 and T5 and the time periods T4 and T5 are partially overlapped with each other. The gate signal lines Gₘ₊₄ and Gₘ₊₅ are enabled in order in respective time periods T5 and T6 and the time periods T5 and T6 are partially overlapped with each other.

Accordingly, compared with a situation that only a single pixel row is charged during a time period, since each two neighboring pixel rows are charged in order and the charging time periods of the two neighboring pixel rows are partially overlapped with each other, at the prerequisite of a given display panel driving frame frequency, the charging time of each pixel can be extended/lengthened in some degree. In addition, due to the gate signal lines Gₘ˜Gₘ₊₅ are independently driven from one another, during the circuit layout design, it is unnecessary to take in consideration that how to avoid arranging other circuit(s) between connected gate signal lines associated with the prior art, and the gate driving signals of gate signal lines Gₘ˜Gₘ₊₅ may not mutually influence and interfere with each other.

As stated above, in the above-mentioned embodiments of the present invention, the pixel charging time can be extended at a given display panel driving frame frequency by using the solution of the gate signal lines being independently driven from one another. Compared with the prior art, it is unnecessary to take in consideration how to avoid arranging other circuit(s) between connected gate signal lines associated with the prior art during the circuit layout design, and the gate driving signals of gate signal lines may not mutually influence and interfere with each other.

Further, one skilled in the art could devise variations of the active matrix display device within the scope and spirit of the invention disclosed herein, for example, varying the electrical connection relationship between each pixel in each pixel row on the TFT array substrate and one of the data signal lines, and/or varying the type of the active matrix display device, such as the liquid crystal layer is replaced with an organic light-emitting diode (OLED) display layer, and so on.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An active matrix display device, comprising:
a plurality of gate signal lines being independently driven from one another;
a plurality of data signal lines; and
a plurality of pixel rows, each of the pixel rows being electrically coupled to one of the gate signal lines and a part of the data signals lines, the pixels rows comprising a first pixel row and a second pixel row;
wherein the first pixel row and the second pixel row are not neighboring with each other, the gate signal line electrically coupled with the first pixel row and the gate signal line electrically coupled with the second pixel row are synchronously enabled.

2. The active matrix display device as claimed in claim 1, wherein the gate signal line electrically coupled with the first pixel row and the gate signal line electrically coupled with the second pixel row has at least one of the rest of the gate signal lines arranged therebetween.

3. The active matrix display device as claimed in claim 1, wherein a total length of charging time for the first pixel row and the second pixel row synchronously receiving display data signals from the data signal lines is substantially equal to a length of charging time for any one of the first pixel row and the second pixel row receiving the display data signals.

4. The active matrix display device as claimed in claim 1, wherein the active matrix display device comprises a color filter substrate, a thin film transistor array substrate and a display layer arranged between the thin film transistor array substrate and the color filter substrate; the gate signal lines, the data signal lines and the pixel rows are arranged on the thin film transistor array substrate.

5. An active matrix display device, comprising:
a first gate signal line and a second signal line being independently driven from each other;
a plurality of data signal lines; and
a first pixel row and a second pixel row respectively electrically coupled to the first gate signal line and the second gate signal line, the first pixel row being electrically coupled to a part of the data signal lines, the second pixel row being electrically coupled to another part of the data signal lines;
wherein the first gate signal line and the second gate signal line are sequentially enabled, and an enabled time period of the first gate signal line and another enabled time period of the second gate signal line are partially overlapped with each other.

6. The active matrix display device as claimed in claim 5, wherein the first pixel row and the second pixel row are neighboring with each other.

7. The active matrix display device as claimed in claim 5, wherein a total length of charging time for the first pixel row and the second pixel row sequentially receiving display data signals from the data signal lines is shorter than the sum of lengths of charging time of the first pixel row and the second pixel row receiving the display data signals.

8. The active matrix display device as claimed in claim 5, wherein the active matrix display device comprises a color filter substrate, a thin film transistor array substrate and a display layer arranged between the thin film transistor array substrate and the color filter substrate; the gate signal lines, the data signal lines and the pixel rows are arranged on the thin film transistor array substrate.
